(19) United States
(12) Patent Application Publication
(10) Pub. No.: US 2003/0224788 A1
(43) Pub. Date: Dec. 4, 2003

(54) Mobile IP roaming between internal and external networks

(75) Inventors: Kent K. Leung, Mountain View, CA (US); Milind M. Kulkarni, San Jose, CA (US); Alpesh Patel, Santa Clara, CA (US)

Correspondence Address: BEYER WEAVER & THOMAS LLP, P.O. BOX 778, BERKELEY, CA, 94704-0778, US

(73) Assignee: Cisco Technology, Inc., San Jose, CA

(21) Appl. No.: 10/150,377

(22) Filed: May 17, 2002

Related U.S. Application Data
(60) Provisional application No. 60/362,251, filed on Mar. 5, 2002.

(51) Int. Cl. H04Q 7/20

(52) U.S. Cl. 455/435.1; 455/466

(57) ABSTRACT

A method and apparatus for registering a mobile node with a home agent are disclosed. The invention uses a Mobile IP proxy to inform the mobile node of whether the mobile node is in an internal network or a remote network. The mobile node sends out a registration request. From the registration request, the Mobile IP proxy determines whether the mobile node is in the internal network or a remote network. In accordance with one embodiment, the Mobile IP proxy sends a notification when the mobile node is in the internal network. For instance, the notification may be provided in an extension to a registration reply. In addition, a home agent may be assigned and identified in the registration reply. This notification may then be used by both a foreign agent to which the mobile node has roamed and the mobile node to update its information for the mobile node. If the mobile node is in a remote network, the Mobile IP proxy acts as an intermediary, creating tunnels to the care-of address and the home agent. Otherwise, the Mobile IP proxy can allow the mobile node and the home agent to communicate with each other without using the Mobile IP proxy as an intermediary.

### CROSS-REFERENCE TO RELATED APPLICATIONS

This application claims the benefit of U.S. Provisional Application No. 60/362,251, filed Mar. 5, 2002, incorporated herein by reference in its entirety and for all purposes.

### BACKGROUND OF THE INVENTION

1. Field of the Invention

The present invention relates generally to mobile computing and more specifically to enabling Mobile IP networks that use firewalls and/or NAT gateways.

2. Description of the Related Art

Mobile IP is a protocol that allows laptop computers and other mobile computer units (“mobile nodes”) to roam between various sub-networks while maintaining Internet and/or WAN connectivity. Without Mobile IP or similar protocols a mobile node would be unable to stay connected while roaming from one location serviced by one sub-network to another location being serviced by a different sub-network. This is because each IP address has a field that specifies the particular sub-network on which the node resides. If a user desires to take a computer that is normally attached to one node and roam so that it passes through different sub-networks, the roaming computer cannot use its home base IP address. As a result, a business person traveling across the country cannot travel with his or her computer across geographically disparate network segments or wireless nodes while maintaining Internet connectivity. This is not acceptable in the age of portable computational devices.

To address this problem, the Mobile IP protocol has been developed and implemented. An implementation of Mobile IP is described in RFC 3220 of the IP Routing for Wireless/Mobile Hosts Working Group, C. Perkins, Ed., October 1996. Mobile IP is also described in the text “Mobile IP, The Internet Unplugged” by J. Solomon, Prentice Hall. Both of these references are incorporated herein by reference in their entireties and for all purposes.

The Mobile IP process and environment are illustrated in FIG. 1. A Mobile IP environment 100 includes the Internet (or a WAN) 105 over which a mobile node 110 can communicate via mediation by a home agent 115 or a foreign agent 120. Typically, the home agent 115 and foreign agent 120 are routers or other network connection devices performing appropriate Mobile IP functions as implemented by software, hardware, and/or firmware. Note the overall network topology is arbitrary, and elements such as the home agent 115 need not directly connect to the Internet 105. For example, the home agent 115 may be connected through another router R2 125. Router R2 125 may, in turn, connect one or more other routers R3 130 with the Internet 105.

When mobile node 110 is plugged into its home network segment 135 it connects with the Internet 105 through its designated home agent 115. When the mobile node 110 roams, it can be connected to a remote network segment 140 and communicate through the available foreign agent 120. Other nodes, such as a PC 145, on remote network segment 140 also communicate with the Internet 105 through foreign agent 120. Presumably, there are many foreign agents available at geographically disparate locations to allow wide spread Internet connection via the Mobile IP protocol.

Mobile node 110 may identify foreign agent 120 through various agent solicitations and agent advertisements which form part of the Mobile IP protocol. When mobile node 110 engages with remote network segment 140, it composes a registration request for the home agent 115 to bind the mobile node's 110 current location with its home location. Foreign agent 120 then relays the registration request 150 to home agent 115. During the registration process, the home agent 115 and the mobile node 110 may then negotiate the conditions of the mobile node's 110 attachment to foreign agent 120. For example, the mobile node 110 may request a registration lifetime of 5 hours, but the home agent 115 may grant only a 3 hour period. When the negotiation is successfully completed, home agent 115 updates an internal “mobility binding table” which links the mobile node's 110 current location via its care-of address (e.g., a co-located care-of address or the foreign agent's IP address) to the identity (e.g., home address) of the mobile node 110. Further, if the mobile node 110 registered via foreign agent 120, the foreign agent 120 updates an internal “visitor table” which specifies the mobile node address, home agent address, etc. The home agent's 115 association between a mobile node's home base IP address, its current care-of address, and the remaining lifetime of that association is referred to as a binding.

If mobile node 110 wanted to send a message to a correspondent node 155 from its new location, the mobile node 110 would forward a packetized output message 160 through the foreign agent 120 over the Internet 105 to the correspondent node 155 according to standard Internet protocols. However, if the correspondent node 155 wanted to send a message 165 to the mobile node 110—whether in reply to a message from the mobile node 110 or for any other reason—the correspondent node 155 addresses that message to the IP address of the mobile node 110 as if the mobile node 110 were on the home network segment 135. The packets of that message are then forwarded over the Internet 105 to router R2 125 and ultimately to home agent 115. From its mobility binding table, home agent 115 recognizes that mobile node 110 is no longer attached to the home network segment 135. It then encapsulates the packets from correspondent node 155 (which are addressed to the mobile node 110 on the home network segment 135) according to the Mobile IP protocol, and forwards these encapsulated packets 170 to the appropriate care-of address for mobile node 110. If the care-of address is the IP address of the foreign agent 120 the foreign agent 120 then strips the encapsulation and forwards the message to mobile node 110 on remote network segment 140. The packet forwarding mechanism implemented by the home agent 115 to the foreign agent 120 is often referred to as “tunneling.”

The Mobile IP approach works in a Mobile IP environment 100 where there are no access restrictions and IP addresses are unique. In reality, however, network access is typically restricted using firewalls, IP address space is usually conserved by reusing addresses, and network address translation (“NAT”) mechanisms that allow a local-area network to use one set of private IP addresses for internal traffic and a second set of public IP addresses for external traffic are frequently employed. These issues pose significant challenges for Mobile IP users.

Due to the existence of firewalls at a private network, a Mobile Node cannot successfully initiate mobile IP sessions while roaming outside the private internal network. The concept of a Mobile IP (MIP) proxy as a solution to this problem was introduced in an IETF working group draft, submitted by F. Adrangi and P. Iyer, “Mobile IPv4 Traversal Across VPN Gateways,” draft-adrangi-mobileip-natvpn-traversal-01, Nov. 13, 2001, incorporated herein by reference in its entirety and for all purposes. While solutions have been proposed using a MIP proxy, these solutions have required that data packets be intercepted by the MIP proxy, regardless of whether the Mobile Node has roamed to a Foreign Agent inside or outside the private internal network. As a result, data traffic is routed unnecessarily to a MIP proxy external to the internal network, even when the Mobile Node remains within the internal network.

In view of the above, it would be beneficial if a MIP proxy could be implemented to more efficiently route data traffic.

### SUMMARY OF THE INVENTION

The present invention provides methods and apparatus for facilitating the registration of a mobile node with a home agent to initiate a Mobile IP session. This is accomplished by routing all registration requests to a Mobile IP (MIP) proxy. The registration request may be sent to a Mobile IP (MIP) proxy directly by a Mobile Node, or indirectly via a Foreign Agent to which the Mobile Node has roamed.

In accordance with one aspect of the invention, the request is then routed to, and is eventually received by, the MIP proxy. The MIP proxy examines the registration request to determine whether the request originated from an internal network or a remote network. It is then the MIP proxy's responsibility to indicate to the mobile node (and foreign agent, as appropriate) whether the request originated from within the internal network or did not originate from within the internal network. This may be accomplished in the registration reply or a message (e.g., error message) separate from the registration reply.

In accordance with another aspect of the invention, the MIP proxy sends an indicator to the mobile node when the mobile node is within its internal network. In accordance with one embodiment, the indicator is sent with a registration reply. In another embodiment, it can be sent before, after, or even in lieu of the processing of the registration request.

In accordance with yet another aspect of the invention, the mobile node receives an indicator of whether the mobile node is within the internal network or is not within the internal network. The indicator can be a positive indicator (i.e., receiving something, such as an error code or an appropriate extension to the registration reply) or a negative indicator (i.e., not receiving anything before the registration reply is received, or no extension being present in the registration reply). Upon receipt of the indicator, the mobile node would then know whether it was in its internal network or in a remote network. In various embodiments, the mobile node may send out a new registration request after this indicator is received.

In accordance with another aspect of the invention, if the mobile node is in a remote network, the MIP proxy acts as an intermediary, creating tunnels to the care-of address and the home agent. Otherwise, the MIP proxy can allow the mobile node and the home agent to communicate with each other without using the Mobile IP proxy as an intermediary. In this manner, the MIP proxy may be eliminated as an intermediary when the mobile node is in its internal network, thereby expediting the forwarding of data traffic.

Yet another aspect of the invention pertains to computer program products including machine-readable media on which are provided program instructions for implementing the methods and techniques described above, in whole or in part. Any of the methods of this invention may be represented, in whole or in part, as program instructions that can be provided on such machine-readable media. In addition, the invention pertains to various combinations and arrangements of data generated and/or used as described herein. For example, registration request and reply packets having the format described herein and provided on appropriate media are part of this invention.

These and other features of the present invention will be described in more detail below in the detailed description of the invention and in conjunction with the following figures.

### BRIEF DESCRIPTION OF THE DRAWINGS

FIG. 1 is a block diagram of a Mobile IP environment;

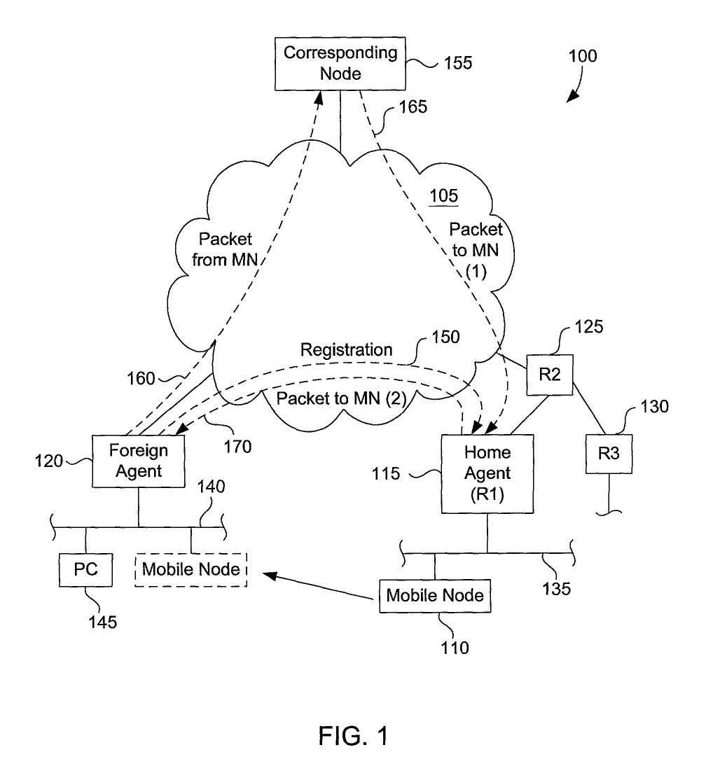

FIG. 2 is a block diagram of a Mobile IP proxy within a Mobile IP environment;

FIG. 3 is a block diagram illustrating an exemplary environment in which the present invention may be implemented;

FIG. 4 is a control flow diagram illustrating a method of processing a registration request originating from a mobile node on an internal network via a foreign agent in accordance with one embodiment of the invention;

FIG. 5 is a control flow diagram illustrating a method of processing a registration request originating from a mobile node on a remote network via a foreign agent in accordance with one embodiment of the invention; and

FIG. 6 is a diagram illustrating an exemplary network device in which embodiments of the invention may be implemented.

### DETAILED DESCRIPTION OF THE PREFERRED EMBODIMENTS

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

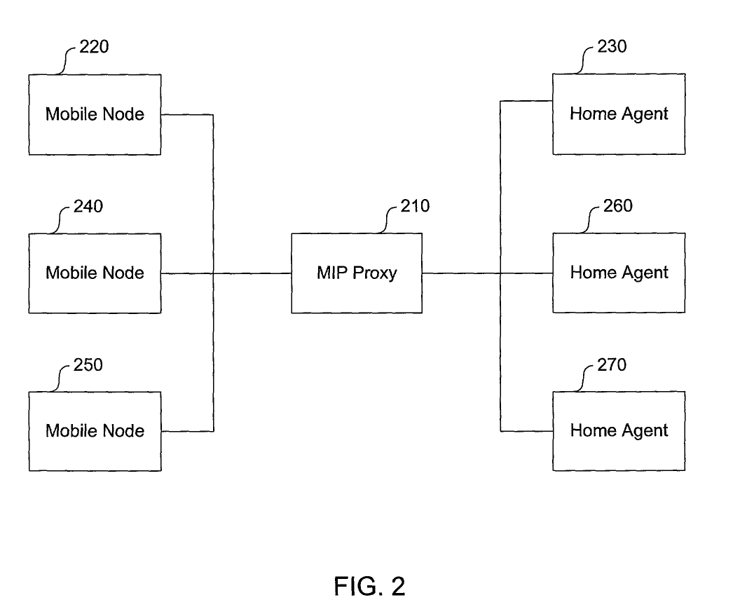

The present invention uses a Mobile IP (MIP) proxy to enable a registration request to be processed by a Home Agent on behalf of a Mobile Node that has roamed outside an internal network that is a private network. FIG. 2 is a block diagram of a Mobile IP proxy within a Mobile IP environment. A MIP proxy 210 is a functional entity that is introduced in the path between a mobile node 220 and one or more corresponding home agents 230. The MIP proxy 210 performs the functions of a surrogate home agent and a surrogate mobile node/foreign agent to “stitch” an end-to-end connection between the mobile node 220 and its home agent 230, respectively. A single MIP proxy 210 may serve multiple mobile nodes 240 and 250 and multiple home agents 260 and 270. Consequently, the MIP proxy 210 can be associated with multiple home sub-networks.

The MIP proxy 210 may be deployed in a demilitarized zone (DMZ) to support authenticated firewall traversal for MIPv4 packets traversing the DMZ from a mobile node 220 with an intervening NAT gateway in its foreign network. The DMZ is a computer host inserted as a “neutral zone” between a company's private network and the outside public network. It prevents outsiders from obtaining direct access to the company's private network. The MIP proxy 210 may be located in the same or a different subnet from any of its associated home agents 230, 260 and 270.

While the IETF draft “Mobile IPv4 Traversal Across VPN Gateways” proposes a partial solution to the initiation of Mobile IP sessions across a firewall, detection of a firewall or NAT gateway has not been achieved. The present invention enables a firewall or NAT gateway to be detected, thereby enabling registration requests to be processed differently depending upon whether the Mobile Node has roamed outside the private internal network or within the private internal network.

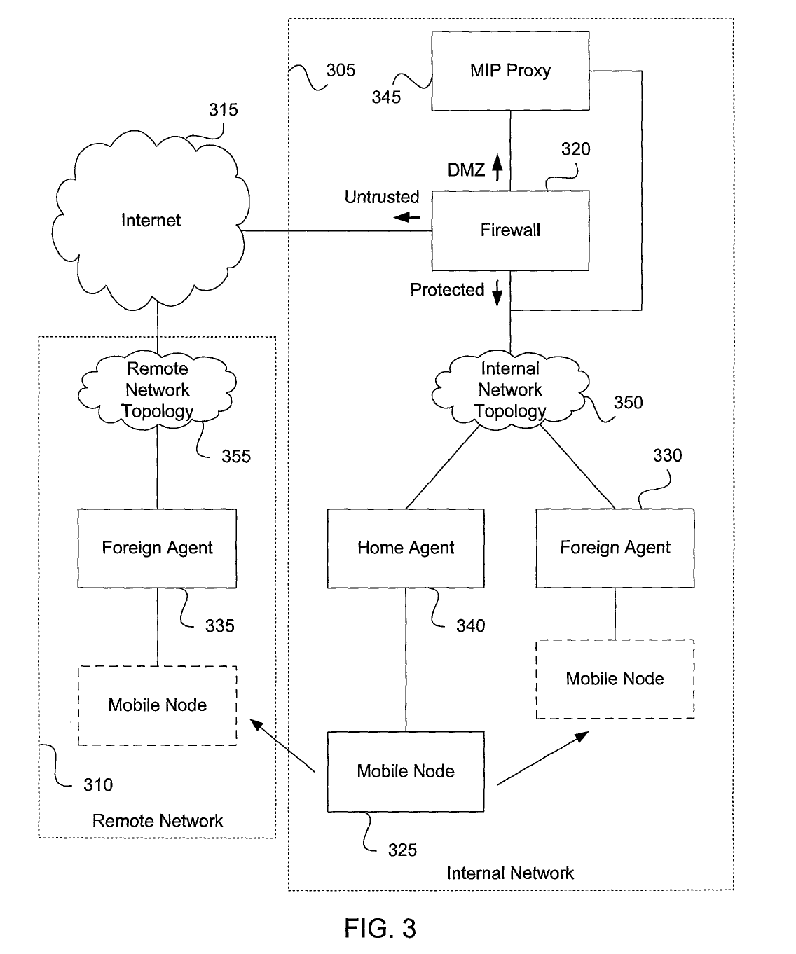

FIG. 3 is a block diagram illustrating an exemplary environment in which the present invention may be implemented. An internal network 305 and a remote network 310 are connected to one another via an Internet 315. The internal network 305 is protected by a firewall 320, which subjects all Internet 315 communications to scrutiny.

When a mobile node 325 roams, it can either roam to a foreign agent 330 in the internal network 305 or a foreign agent 335 in the remote network 310. Regardless of the location of the foreign agent to which the mobile node 325 roams, in accordance with various embodiments of the invention, the mobile node 325 always initiates a registration request with its MIP proxy 345. The MIP proxy 345 preferably sits in the DMZ (i.e., between the Internet 315 and the internal network topography 350). When the mobile node 325 roams into the remote network 310, the MIP proxy 345 is capable of acting as a surrogate home agent for the mobile node 325 and a surrogate mobile node for the home agent 340. In accordance with one embodiment, the MIP proxy 345 is deployed in conjunction with an IPsec-compatible virtual private network (VPN) gateway or functionally integrated with a VPN gateway in a DMZ.

It should be noted that any arbitrary topology 350 can be associated with the internal network 305, and only the components relevant to the present discussion are being discussed. Similarly, the remote network 310 can also have any arbitrary network topology 355 associated with it.

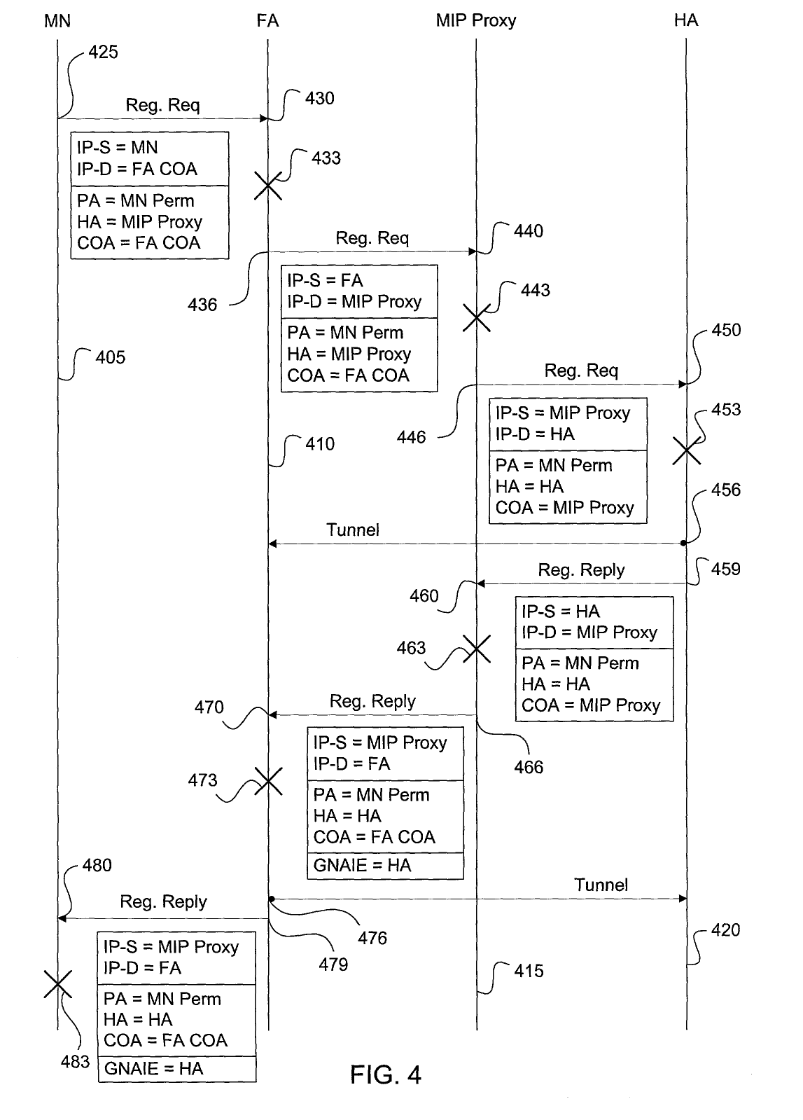

FIG. 4 is a control flow diagram illustrating a method of processing a registration request originating on the internal network 305 via a foreign agent 330 in accordance with an embodiment of the invention. Steps performed by the mobile node 325, foreign agent 330, MIP proxy 345, and home agent 340 are represented by corresponding vertical lines 405, 410, 415, and 420.

When the mobile node 325 hears a foreign agent advertisement and detects that it has roamed to a particular foreign agent, it initiates registration. If the foreign agent 330 receives a registration request from the mobile node 325, the foreign agent's IP address serves as the care-of address, then, as shown at 425, the mobile node 325 sends a registration request to the foreign agent 330 with the IP source address equal to the mobile node's home address and the IP destination address equal to the foreign agent's IP address (interface sending agent advertisements). Otherwise, if the mobile node 325 had received a co-located care-of address, it would register itself directly (not shown in FIG. 4), and the IP destination address would be the MIP Proxy address.

One standardized method for identifying users is proposed in RFC 2486 of the Network Working Group, January 1999, hereby incorporated by reference, which proposes syntax for the Network Access Identifier (NAI), the userID submitted by a client during Point to Point Protocol (PPP) authentication. Thus, when a client is authenticated based upon the NAI, an IP address (i.e., Home Address) may be allocated for use by the client. For instance, the mobile node may be configured with a NAI such as mn1@cisco.com. In addition, in this example, the mobile node is configured with a generic Home Agent name (e.g., domain name) for the internal network (i.e., private network) in the form of ha.cisco.com. In accordance with one embodiment, this Home Agent name is then mapped to the Mobile IP Proxy (MIPP) in a Domain Name System (DNS) server. The NAI may be transmitted in an NAI extension in a registration request while the Home Agent name may be transmitted in a generalized NAI extension (GNAIE) to the registration request.

The registration request includes a Home Address field equal to the IP address (i.e., Home Address) of the mobile node 325, a home agent address equal to address of the MIP proxy 345, and a care-of address equal to the appropriate care-of address (e.g., foreign agent address or co-located care-of address. Since the mobile node may be programmed with the generic HA name, it provides the generic HA name in a generalized network access identifier extension (GNAIE). The GNAIE is fully described in the IETF working group draft. “Generalized NAI (GNAI) Extension for Mobile IPv4,” Khalil, M., Qaddoura, E, Akhtar, H., and Calhoun, P., draft-ietf-mobileip-gnaie-05.tx, October 2001, incorporated herein by reference in its entirety and for all purposes. As one skilled in the art will appreciate, the registration request can be set up differently, depending on the other components of the system. For example, the home agent address can be set equal to zero (signaling that a home agent has not yet been assigned), while the GNAIE can identify the MIP proxy 345, as described above. In such an embodiment, the foreign agent 330 would need to be capable of parsing and interpreting the GNAIE correctly. Once the MIP proxy 345 receives the registration request, the MIP proxy 345 may select one of a plurality of home agents as shown in FIG. 2. Alternatively, the MIP proxy 345 could be relied upon to maintain a list of mobile nodes and their associated home agents. Regardless of how the registration request is actually formed, it should be designed to be routed through the MIP proxy 345 before reaching the home agent 340 or other home agent selected by the MIP proxy 345 (not shown).

Referring back to FIG. 4, the foreign agent 330 receives the registration request at 430. Both the foreign agent 330 and the mobile node typically maintain information associated with pending requests. In this manner, the foreign agent 330 and/or mobile node may ascertain whether a request is pending and the Home Agent to which the registration request was sent. At 433 the foreign agent forwards the registration request to the MIP proxy. Thus, as shown, the IP destination address is the MIP proxy address. The MIP proxy address information can be transmitted in the registration request either as an IP address or a domain name that would be translated into an IP address via a DNS lookup. Thus, in accordance with one embodiment, the foreign agent parses the GNAIE and extracts the home agent name. The foreign agent then performs a DNS lookup on the home agent name to obtain the IP address of the Mobile IP proxy. In accordance with one embodiment, in the absence of a Foreign Agent, the Mobile Node performs a DNS lookup on the home agent name to obtain the MIP proxy address. The MIP proxy address can point directly to the MIP proxy 345 or indirectly to some system (such as the Distributed Director product available from Cisco Technology, Inc) that assigns an appropriate MIP proxy based on geography, load, or any other metrics considered relevant. At 436 the foreign agent 330 forwards the registration request to the MIP proxy 345.

The MIP proxy 345 receives the registration request at 440 and identifies an appropriate Home Agent (e.g., topologically nearest). The Home Agent field may include an IP address of the MIP Proxy. Alternatively, as described above, the Home Agent field or other portion of the registration request may indicate that a Home Agent is to be dynamically assigned to the Mobile Node. For instance, the Home Agent field may be set to zero. The selection of a Home Agent may be performed by the MIP proxy itself or by another entity such as a Home Agent Director. Alternatively, if the Home Agent field of the registration request includes the IP address of the MIP proxy 345, the MIP proxy may process the registration request as the Home Agent for the Mobile Node.

The MIP proxy 345 also determines whether the registration request originated from the internal network 305 (i.e., private network) or the remote network 310 (i.e., public or private foreign network). More particularly, the MIP proxy 345 checks if the source IP address belongs to any internal subnets to determine whether the registration request originated from the internal network. For instance, if the source IP address is not associated with any internal subnets, then the registration request did not originate from the internal network. Specifically, when the registration request received from the mobile node 325 originated from the internal network rather than a remote network, the Mobile Node does not need to continue using the MIP proxy 345 as an intermediary to its home agent 340 and can safely use IP-in-IP tunneling (RFC 2003). IP-in-IP tunnels cannot generally pass through a NAT, and therefore prohibits Mobile IP from being used across a network using a NAT. One proposed solution is to use IP-in-UDP tunneling. Levkowetz, H. and Vaarala, S., “Mobile IP NAT/NAPT Traversal using UDP Tunneling,” draft-ietf-mobileip-nattraversal-02.txt, Apr. 5, 2002, incorporated herein by reference in its entirety and for all purposes. Thus, IP-in-UDP tunnels are often used, as they allow Mobile IP sessions to be initiated across firewalls. However, IP-in-IP tunnels are more efficient, since they are processed at network layer (3), not transport layer (4) UDP. Accordingly, in accordance with various embodiments of the invention, IP-in-IP tunneling is used when the Mobile Node has roamed to a Foreign Agent within the private network.

The MIP proxy 345 can use any number of methods of assigning a home agent, basing the decision on relevant metrics, through table-lookup, or simply through random assignment. Additionally, the MIP proxy 345 can use systems, such as those described in copending application titled “Methods And Apparatus For Mobile IP Dynamic Home Agent Allocation,” by Kent K. Leung, Alpesh Patel, and Stefan B. Raab, Attorney Docket Number of CISCP287, incorporated herein by reference in its entirety and for all purposes, to select an appropriate home agent.

At 446 the MIP proxy 345 composes a new registration request and forwards the registration request to the home agent 340. The new registration request has an IP source address equal to the IP address of the MIP proxy 345, an IP destination address equal to the IP address of the home agent 340, a home address equal to the IP address of the mobile node 325 or 0, a home agent address equal to the IP address of the selected home agent 340 or 0 (0 if original registration request had it as 0), and a care-of address. More specifically, the care-of address is the co-located care-of address.

The home agent 340 receives the request at 450 and performs standard Mobile IP processing according to RFC 3220 at 453. In accordance with the Mobile IP standard, it sets up an IP-in-IP tunnel (or, optionally, a GRE tunnel, as described in RFC 1702 and RFC 2784), to the foreign agent at 456. When the Home Agent creates the tunnel, it sets the tunnel endpoint to the care-of address and sends a registration reply to the MIP proxy 345 at 459. The registration reply includes an IP source address equal to the IP address of the home agent 340, an IP destination address equal to the MIP proxy 345, a home address equal to the IP address of the mobile node 325, a home agent address equal to address of the home agent 340, and a care-of address equal to the care-of address field in the registration request.

The MIP proxy 345 receives the registration reply at 460 and updates its state at 463 by mapping the mobile node in the mobility binding table with the home agent in the registration table. In other words, a registration table (typically maintained by a mobile node) may be maintained that identifies a Mobile Node with a particular Home Agent. Thus, a registration table entry may be updated with a reference to the associated mobility binding entry. In addition, a mobility binding table (typically maintained by a Home Agent) may store bindings that associate the Mobile Node with a particular care-of-address. The binding is updated with a reference to the registration table entry. The MIP proxy 345 creates tunnels to the Home Agent and the Mobile Node. At 466 the MIP proxy 345 forwards the registration reply to the foreign agent 330. As shown, the registration reply includes an IP source address equal to the address of the MIP proxy 345 and an IP destination address equal to the care-of-address as received in original registration request.

In accordance with various embodiments of the invention, the MIP proxy appends an Internal Home Agent address extension to the registration reply prior to sending the registration reply to the foreign agent 330. More specifically, the presence of the Internal Home Agent address extension may indicate that the Mobile Node is inside the private internal network. Alternatively, information within this extension may also be used to indicate whether the Mobile Node is inside the private internal network. This is important to enable a reverse tunnel to be created between the care-of address (Mobile Node or Foreign Agent) and the selected Home Agent. In other words, since information regarding pending requests is typically maintained by the Mobile Node and the Foreign Agent, this information will correspond to the MIP proxy IP address rather than the selected Home Agent address. As described above, the pending registration requests will be identified with the MIP proxy rather than the Home Agent that is ultimately selected. Therefore, the presence of this extension to the registration reply packet signals that the Mobile Node and the Foreign Agent are to update this information to identify the tunnel endpoint. In addition, the presence of this extension may also indicate that the tunnel mode to be used is IP-in-IP or GRE rather than IP-UDP. Thus, the UDP tunnel reply extension as defined in draft-eiftmobileip-nat-traveral-02.txt, is not included in the registration reply packet.

The foreign agent 330 receives the registration reply at 470 and performs standard Mobile IP processing as set forth in RFC 3220 at 473. At 476 the foreign agent 330 creates a tunnel to the home agent 340 as described above. More specifically, the foreign agent 330 creates an IP-in-IP or GRE tunnel to the Home Agent IP address in the extension of the registration reply. Then, at 479, the foreign agent 330 forwards the registration reply to the mobile node 325. The mobile node 325 receives the registration reply at 480. At 483 the mobile node 325 processes the registration reply, completing the registration process. As described above, if the mobile node has registered without a Foreign Agent, the mobile node establishes a reverse tunnel to the Home Agent. In addition, it updates its information regarding pending registrations such that the selected Home Agent is associated with those pending registrations.

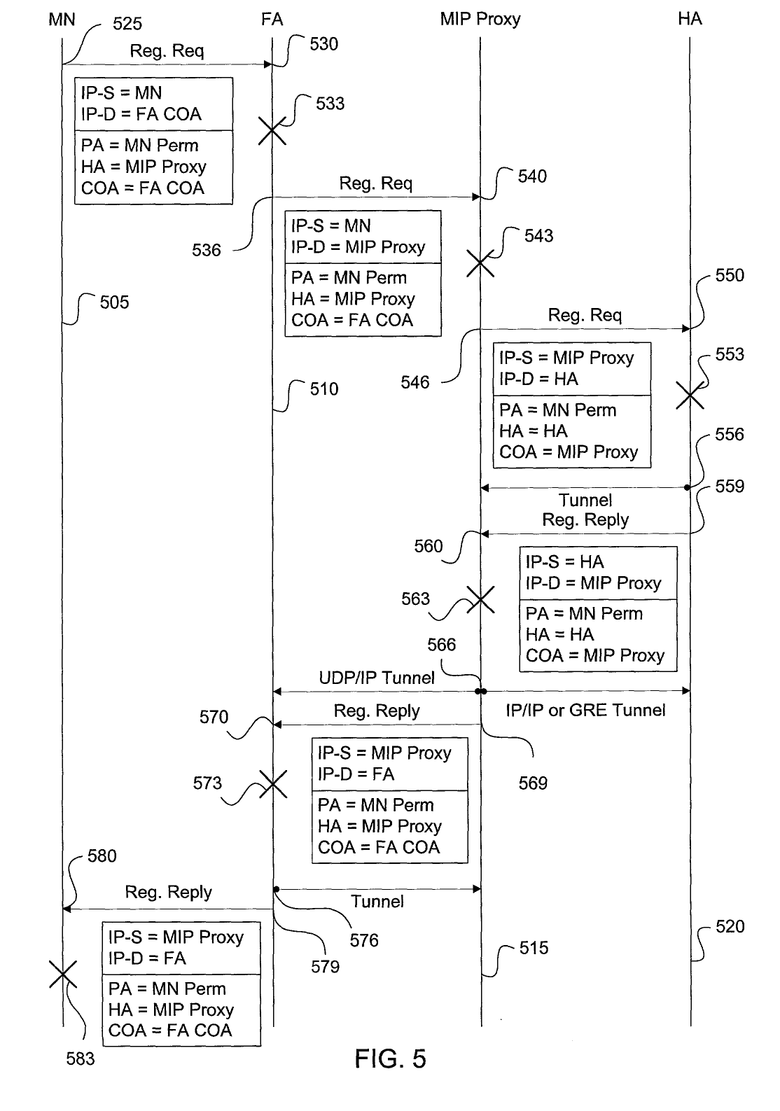

FIG. 5 is a control flow diagram illustrating a method of processing a registration request originating on the remote network 310 via a foreign agent 335 in accordance with an embodiment of the invention. Steps performed by the mobile node 325, foreign agent 330, MIP proxy 345, and home agent 340 are represented by corresponding vertical lines 505, 510, 515, and 520.

Since the mobile node 325 and the foreign agent 330 have no knowledge of whether they are inside the internal network 305 or the remote network 310, steps 525, 530, 533, 536 and 540 are identical to 425, 430, 433, 436 and 440, respectively, of FIG. 4. At 543 the MIP proxy 345 examines the registration request and determines that the mobile node 325 is outside the internal network 305, as described above with reference to FIG. 4. The MIP proxy 345 additionally assigns the home agent 340 as necessary.

Although FIG. 5 shows the MIP proxy 345 proceeding with registration at 546, the system can be set up to immediately notify the mobile node 325 that it is outside the internal network 305. One convenient method of notifying the mobile node 325 that it is in the remote network 310 is by returning a specific error message (not shown in FIG. 5). The mobile node 325 would interpret the message to mean that it should switch to IP-in-UDP tunneling from IP-in-IP (or GRE) tunneling. Additionally, the mobile node 325 would know to not attempt a direct tunnel to its home agent, but, instead, use the MIP proxy 334 as an intermediary. The error message could then either prompt the mobile node 325 to re-send its registration request or the MIP proxy 345 could be configured to continue with its registration process without waiting to receive a new registration request.

In accordance with one embodiment, the mobile node 325 is not notified that it is in the remote network until after the home agent 340 processes the registration request. Regardless of when the mobile node 325 receives some type of indicator, the mobile node 325 eventually determines that it is not in the internal network 305. If the mobile node 325 was oblivious to its location, and attempted regular registration, the firewall 320 would pass the registration request and the registration reply, but would block tunnel traffic.

At 546 the MIP proxy 345 composes or modifies a registration request and sends it to the home agent 340. In order ensure that it will intercept data packets subsequently sent to the mobile node, the MIP proxy sets the care-of address to the internal/private IP address of the MIP proxy 345. The home agent 340 processes the registration request as specified in the IETF draft referred to above. More specifically, the home agent 340 processes the registration request at 553 and sets up a tunnel to the MIP proxy 345 at 556.

A registration reply is sent to the MIP proxy 345 at 559. Since the home agent 340 received a registration request with a care-of address equal to the address of the MIP proxy 345, the care-of address field of the registration reply would also be equal to the MIP proxy 345.

The MIP proxy 345 receives the registration reply at 560 and updates its state at 563, as described above with reference to FIG. 4. More specifically, in the MIP proxy's mobility binding table and visitor table, the mobile node will be seen as having a Home Agent equal to the selected Home Agent and a care-of address equal to the care-of address (e.g., Foreign Agent address). At 566 the MIP proxy 345 forms a first tunnel to the home agent 340 and a second tunnel to the appropriate care of address (in this case, the foreign agent 335 or co-located care-of-address). Then, at 569, the MIP proxy 345 forms a registration reply and sends it to the foreign agent 330. The MIP proxy 345 registration reply has an IP source address equal to the public address of the MIP proxy 345, an IP destination address equal to the foreign agent 330 (or co-located care-of-address in the absence of a foreign agent), a home address equal to the IP address of the mobile node 325, a home agent address equal to address of the MIP proxy 345, and a care-of address equal to the appropriate care-of address. Since the registration reply does not include an Internal Home Agent address extension, the mobile will recognize that the mobile node is outside the internal network. Thus, the mobile node will know that it should use IP-in-UDP tunneling as appropriate. For instance, when a co-located care-of address is being used, it creates a reverse tunnel to the MIP proxy (rather than its Home Agent). The mobile node and the foreign agent will therefore continue to route data packets to and from the mobile node via the MIP proxy.

The foreign agent 335 receives the registration reply at 570, processes it at 573 to update its visitor table. At 576 the foreign agent 330 creates a tunnel to the MIP proxy 345. Then, at 579, the foreign agent forwards the registration reply to the mobile node 325, which receives the registration reply at 580. At 583 the mobile node 325 processes the registration reply, and sees that the MIP proxy 345 has determined that the mobile node 325 is outside the internal network 305. The Mobile Node will therefore continue to receive and route data packets via the MIP proxy.

If the mobile node 325 is registering from a foreign network without a foreign agent and the foreign network uses public addresses, there is no NAT traversal incurred at the foreign network. Thus, the mobile node 325 could register normally (as per RFC-3220) and request IP-in-IP or GRE tunneling. The MIP proxy 345 would detect that the mobile node 325 is in a foreign network and cause the mobile node 325 to use UDP/IP tunneling by either rejecting the request with a specific error code or adding the home address parameter extension.

In accordance with various embodiments, the present invention implements a MIP proxy to establish a Mobile IP session with a Mobile Node that has roamed from a private network. The MIP proxy determines whether the Mobile Node is in the private internal network or a public remote network. Depending upon this determination, tunneling is set up to most efficiently route data packets. In other words, when the Mobile Node has not roamed outside the private network, there is no need to route packets via the MIP proxy. Thus, the tunneling is performed such that data packets need not be routed through the MIP proxy when the Mobile Node remains in the internal network. In this manner, the present invention ensures that data traffic does not go outside the private internal network when the Mobile Node has roamed to a Foreign Agent within the internal network.

Generally, the techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the techniques of this invention may be implemented on a general-purpose programmable machine selectively activated or reconfigured by a computer program stored in memory. Such a programmable machine may be a network device designed to handle network traffic, such as, for example, a router or a switch. Such network devices may have multiple network interfaces including frame relay and ISDN interfaces, for example. Specific examples of such network devices include routers and switches. For example, home agents, MIP proxies, and foreign agents of this invention may be implemented in specially configured routers, switches or servers, such as specially configured router models 2600, 3200, 3600, 4500, 7200, and 7500 available from Cisco Systems, Inc. of San Jose, Calif. A general architecture for some of these machines will appear from the description given below. In an alternative embodiment, the techniques of this invention may be implemented on a general-purpose network host machine such as a personal computer or workstation. Further, the invention may be at least partially implemented on a card (e.g., an interface card) for a network device or a general-purpose computing device.

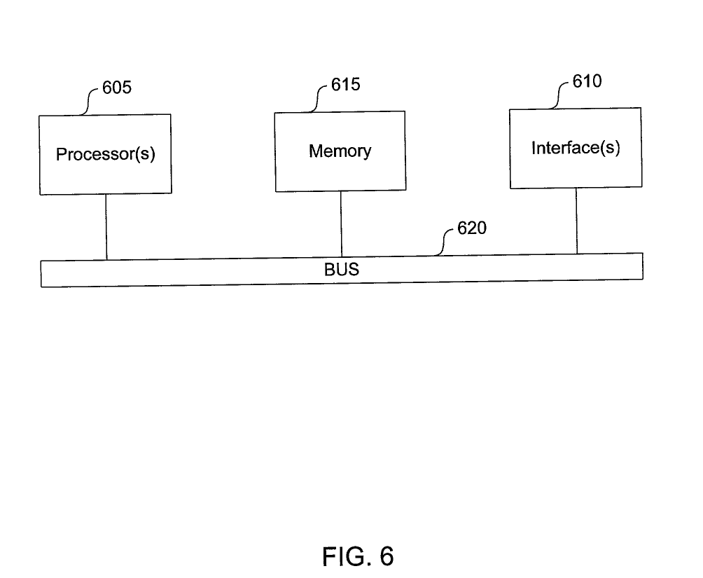

Referring now to FIG. 6, a network device 600 suitable for implementing the techniques of the present invention includes a master central processing unit (CPU) 605, interfaces 610, memory 615 and a bus 620. When acting under the control of appropriate software or firmware, the CPU 605 may be responsible for implementing specific functions associated with the functions of a desired network device. For example, when configured as an intermediate router, the CPU 605 may be responsible for analyzing packets, encapsulating packets, and forwarding packets for transmission to a set-top box. The CPU 605 preferably accomplishes all these functions under the control of software including an operating system (e.g. Windows NT), and any appropriate applications software.

CPU 605 may include one or more processors such as those from the Motorola family of microprocessors or the MIPS family of microprocessors. In an alternative embodiment, the processor is specially designed hardware for controlling the operations of network device 600.

The interfaces 610 are typically provided as interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces, ASI interfaces, DHEI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the CPU 605 to efficiently perform routing computations, network diagnostics, security functions, etc.

Although the system shown in FIG. 6 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, the memory 615) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is described as being configured to comply with Mobile IP standards in force as of the time this document was written. However, it should be understood that the invention is not limited to such implementations. For example, if the default tunnel used by mobile nodes were IP-in-IP (or some other tunnel that is capable of being used across NATs and firewalls), then no mechanism would be necessary to inform the mobile node 325 to switch to that type of tunnel. Accordingly, the present embodiments are to be considered as illustrative and not restrictive, and the invention is not to be limited to the details given herein, but may be modified within the scope and equivalents of the appended claims.

What is claimed is:

1. A method of registering a mobile node with a home agent to initiate a Mobile IP session comprising:
sending a registration request to a Mobile IP proxy, the registration request being independent of whether the mobile node is within an internal network or a remote network;
receiving an indicator from the Mobile IP proxy of whether the mobile node is within its internal network or is not within its internal network; and
receiving a registration reply.

2. The method of claim 1, further comprising:
sending a registration renewal message to a Mobile IP proxy.

3. The method of claim 1, wherein the presence of the indicator indicates that the mobile node is in the internal network and the absence of the indicator indicates that the mobile node is not in the internal network.

4. The method of claim 3, wherein the indicator is contained within an extension to the registration reply.

5. The method as recited in claim 4, wherein the extension identifies the home agent.

6. The method of claim 3, wherein the indicator is an error message.

7. The method of claim 1, wherein the presence of the indicator indicates that the mobile node is in the internal network and the absence of the indicator indicates that the mobile node is not in the internal network.

8. The method of claim 7, wherein the indicator is an error message.

9. The method of claim 7, wherein the indicator is contained within an extension to the registration reply.

10. The method of claim 1, wherein the registration reply was generated by the Mobile IP proxy in response to a registration reply from the home agent.

11. The method of claim 1, further comprising:
using IP-in-UDP tunneling for the Mobile IP session if the indicator indicates that the mobile node is in a remote network.

12. The method of claim 11, further comprising:
using IP-in-IP tunneling for the remainder of the Mobile IP session if the indicator indicates that the mobile node is in the internal network.

13. The method of claim 11, further comprising:
using IP-in-GRE tunneling for the remainder of the Mobile IP session if the indicator indicates that the mobile node is in the internal network.

14. The method of claim 11, further comprising:
forming a tunnel to the Mobile IP proxy if an indicator indicating that the Mobile Node is in the remote network was received and if a co-located care-of address is being used; and
forming a tunnel to the home agent if an indicator indicating that the Mobile Node is in the internal network was received and if a co-located care-of address is being used.

15. The method of claim 1, wherein the registration request includes an extension that identifies the Mobile IP proxy.

16. The method of claim 1, wherein the registration request includes an extension that includes a generic Home Agent name.

17. The method of claim 16, wherein the generic Home Agent name corresponds to the Mobile IP proxy.

18. The method of claim 1, wherein the registration request includes an extension that includes a domain name of the Home Agent, thereby enabling the domain name to be mapped to an IP address of the Mobile IP proxy by a DNS server.

19. The method of claim 1, wherein the registration request includes an extension that identifies the home agent.

20. The method of claim 1 wherein the method is executed by the mobile node and stored as instructions on a computer-readable medium.

21. A network device adapted for registering a mobile node with a home agent to initiate a Mobile IP session comprising:
a processor; and
a memory, at least one of the processor and the memory being adapted for:
sending a registration request to a Mobile IP proxy;
receiving an indicator from the Mobile IP proxy of whether the mobile node is within its internal network or is not within its internal network; and
receiving a registration reply.

22. The network device as recited in claim 21, wherein the network device is a mobile node.

23. A network device configured for registering a mobile node with a home agent to initiate a Mobile IP session comprising:
means for sending a registration request to a Mobile IP proxy;
means for receiving an indicator from the Mobile IP proxy of whether the mobile node is within its internal network or is not within its internal network; and
means for receiving a registration reply.

24. A method of facilitating the registration of a mobile node with a home agent for a Mobile IP session comprising:
receiving a registration request from the mobile node that includes a care-of address;
examining the registration request to determine whether the request originated from an internal network or a remote network;
indicating to the mobile node whether the request originated from within the internal network or did not originate from within the internal network; and
sending a registration reply to the mobile node.

25. The method as recited in claim 24, wherein indicating to the mobile node whether the request originated from within the internal network or did not originate from within the internal network comprises:
sending an indicator from the Mobile IP proxy of whether the mobile node is within its internal network or is not within its internal network

26. The method of claim 25, wherein the presence of the indicator indicates that the mobile node is in the internal network and the absence of the indicator indicates that the mobile node is not in the internal network.

27. The method of claim 26, wherein the indicator is contained within an extension to the registration reply.

28. The method as recited in claim 26, wherein the extension identifies the home agent.

29. The method of claim 25, wherein the presence of the indicator indicates that the mobile node is in the internal network and the absence of the indicator indicates that the mobile node is not in the internal network.

30. The method of claim 30, wherein the indicator is contained within an extension to the registration reply.

31. The method of claim 29, wherein the registration reply was generated by the Mobile IP proxy in response to a registration reply from the home agent.

32. The method of claim 25, further comprising:
forming a first tunnel to the home agent in response to determining that the request did not originate from the internal network;
forming a second tunnel to the care-of address in response to determining that the request did not originate from the internal network.

34. The method of claim 32, wherein indicating to the mobile node is achieved by sending an error message to the mobile node when the mobile node is within the internal network and not sending an error message to the mobile node when the mobile node is not within the internal network.

34. The method of claim 32, wherein indicating to the mobile node is achieved by sending an error message to the mobile node when the mobile node is not within the internal network and not sending an error message to the mobile node when the mobile node is within the internal network.

35. The method of claim 32, further comprising:
examining the registration request to determine whether a home agent has been identified; and
obtaining a home agent assignment if no home agent was identified.

36. The method of claim 32, wherein the method is executed by a MIP proxy and stored as instructions on a computer-readable medium.

27. A network device adapted for facilitating the registration of a mobile node with a home agent for a Mobile IP session comprising:
a processor; and
a memory, at least one of the processor and the memory being adapted for:
receiving a registration request from the mobile node that includes a care-of address;
examining the registration request to determine whether the request originated from an internal network or a remote network;
indicating to the mobile node whether the request originated from within the internal network or did not originate from within the internal network; and
sending a registration reply to the mobile node.

28. A network device adapted for facilitating the registration of a mobile node with a home agent for a Mobile IP session comprising:
means for receiving a registration request from the mobile node that includes a care-of address;
means for examining the registration request to determine whether the request originated from an internal network or a remote network;
means for indicating to the mobile node whether the request originated from within the internal network or did not originate from within the internal network; and
means for sending a registration reply to the mobile node.
